(19) United States
(12) Patent Application Publication
(10) Pub. No.: US 2015/0268572 A1
(43) Pub. Date: Sep. 24, 2015

(54) ELECTROSTATIC CHARGE IMAGE DEVELOPING TONER, ELECTROSTATIC CHARGE IMAGE DEVELOPER, DEVELOPER CARTRIDGE, PROCESS CARTRIDGE, AND IMAGE FORMING APPARATUS

(71) Applicant: Fuji Xerox Co., Ltd., Tokyo (JP)

(72) Inventors: Shotaro TAKAHASHI, Kanagawa (JP); Atsushi SUGITATE, Kanagawa (JP); Masaru TAKAHASHI, Kanagawa (JP); Shuji SATO, Kanagawa (JP); Satomi HARA, Kanagawa (JP); Sakiko HIRAI, Kanagawa (JP)

(21) Appl. No.: 14/589,431

(22) Filed: Jan. 5, 2015

(30) Foreign Application Priority Data
Mar. 20, 2014 (JP) 2014-058855

(51) Int. Cl. G03G 9/00

(52) U.S. Cl. CPC G03G 9/0827; G03G 9/0902

(57) ABSTRACT

An electrostatic charge image developing toner includes flake shape toner particles containing a binder resin and a flake shape brilliant pigment, and the toner particles satisfying the following expression:

1≦L≦3

wherein L represents an average distance (μm) between a tangent line A of the toner particle that is orthogonal to a long axis direction of the toner particle and a tangent line B of the brilliant pigment that is parallel to the tangent line A and closest to the tangent line A.

### CROSS-REFERENCE TO RELATED APPLICATIONS

This application is based on and claims priority under 35 USC 119 from Japanese Patent Application No. 2014-058855 filed Mar. 20, 2014.

### BACKGROUND

### Technical Field

The present invention relates to an electrostatic charge image developing toner, an electrostatic charge image developer, a developer cartridge, a process cartridge, and an image forming apparatus.

### SUMMARY

According to an aspect of the invention, there is provided an electrostatic charge image developing toner including:

flake shape toner particles containing a binder resin and a flake shape brilliant pigment,

and the toner particles satisfying the following expression:

1≦L≦3

wherein L represents an average distance (μm) between a tangent line A of the toner particle that is orthogonal to a long axis direction of the toner particle and a tangent line B of the brilliant pigment that is parallel to the tangent line A and closest to the tangent line A.

### BRIEF DESCRIPTION OF THE DRAWINGS

Exemplary embodiments of the present invention will be described in detail based on the following figures, wherein:

FIG. 1 is a diagram for illustrating a method of calculation of an average distance between a tangent line A and a tangent line B;

FIG. 2 is a cross-sectional view schematically showing an example of toner particles of the exemplary embodiment;

FIG. 3 is a schematic configuration diagram showing an example of an image forming apparatus of the exemplary embodiment; and

FIG. 4 is a schematic configuration diagram showing an example of a process cartridge of the exemplary embodiment.

### DETAILED DESCRIPTION

Hereinafter, exemplary embodiments of a brilliant toner, an electrostatic charge image developer, a developer cartridge, a process cartridge, an image forming apparatus, and an image forming method of the invention will be described in detail.

Brilliant Toner

The brilliant toner of the exemplary embodiment (hereinafter, referred to as a “toner” in some cases) includes flake shape toner particle which contain a binder resin and a flake shape brilliant pigment and in which an average distance between a tangent line A of the toner particle which is orthogonal to a long axis direction of the toner particle and a tangent line B of the brilliant pigment which is parallel to the tangent line A and is closest to the tangent line A (hereinafter, referred to as “A-B average distance” in some cases) is from 1 μm to 3 μm.

Hereinafter, the “long axis direction” means a direction of the longest axis.

Hereinafter, the A-B average distance of the toner particles will be described with reference to the drawing.

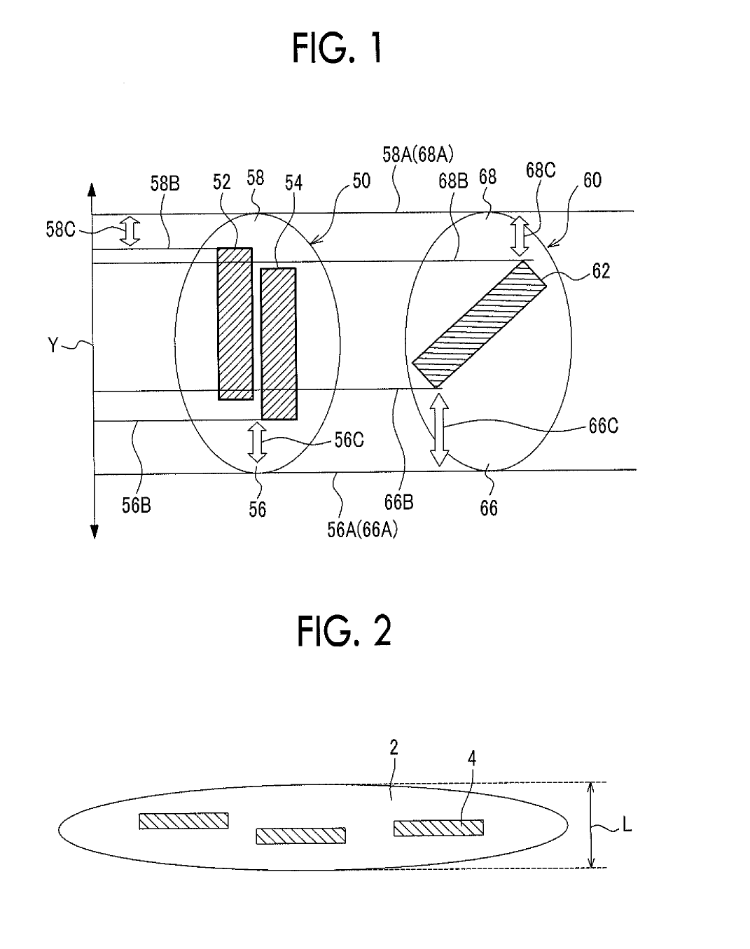

FIG. 1 is a diagram schematically showing the projection image of the toner particles.

A toner particle 50, for example, contains flake shape brilliant pigments 52 and 54, and the toner particle 50 has a flake shape. The brilliant pigments 52 and 54 are arranged in a line along a long axis direction Y of the toner particle 50.

A toner particle 60, for example, contains a flake shape brilliant pigment 62, and the toner particle 60 has a flake shape. A long axis direction of the brilliant pigment 62 has an angle with respect to the long axis direction Y of the toner particle 60.

The A-B distance of the toner particle 50 is obtained as follows.

First, for one end 56 in the long axis direction Y of the toner particle 50, a distance 56C between a tangent line 56A which contacts the surface of the toner particle 50 and is orthogonal to the long axis direction Y, and a tangent line 56B which contacts the surface of the brilliant pigment 52 or 54, is parallel to the tangent line 56A, and is closest to the tangent line 56A (tangent line of the brilliant pigment 54), is obtained.

In the same manner as described above, for the other end 58 in the long axis direction Y of the toner particle 50, a distance 58C between a tangent line 58A which contacts the surface of the toner particle 50 and is orthogonal to the long axis direction Y, and a tangent line 58B which contacts the surface of the brilliant pigment 52 or 54, is parallel to the tangent line 58A, and is closest to the tangent line 58A (tangent line of the brilliant pigment 52), is obtained.

The distance 56C and the distance 58C is the A-B distance of the toner particle 50.

Also, for the toner particle 60, first, a distance 66C between a tangent line 66A and a tangent line 66B for one end 66 of the toner particle 60, and a distance 68C between a tangent line 68A and a tangent line 68B for the other end 68 is obtained as the A-B distance.

As a method of actually measuring the A-B average distance of the toner particle contained in the toner, the following method is used, for example.

Specifically, first, 0.1 parts of the toner, 4 parts of ion exchange water, 0.01 parts of an anionic surfactant (NEOGEN R manufactured by Dai-Ichi Kogyo Seiyaku Co., Ltd.) are mixed with each other and a dispersion is prepared. Next, regarding the dispersion, projection images of 4500 toner particles in the dispersion are observed using a flow type particle image analyzer FPIA-3000 (manufactured by Sysmex Corporation). For each toner particle, the A-B distance obtained by the method is obtained, and the “A-B average distance of the toner particle contained in the toner” is calculated.

Since the projection image of the toner particle obtained by the observation has different levels of brightness of the image depending on the presence of the brilliant pigment, a region (dark part) where the brilliant pigment is present and a region of a resin layer (bright part) where the brilliant pigment is not present is distinguished due to the brightness of the projection image.

The brilliant toner of the exemplary embodiment has the configuration described above, and therefore an image defect derived from the scattering of the toner is prevented, compared to a case where the A-B average distance is shorter than the range described above. The reason thereof is not clear, but is presumed to be as follows.

As described above, the toner particle included in the toner of the exemplary embodiment contains the flake shape brilliant pigments, and the toner particle has a flake shape. The brilliant pigment has conductivity (for example, volume resistivity of less than 10⁷ Ω·cm). Accordingly, in a case of performing the image forming using the toner described above, it is found that a transferred toner particle is in a standing-up state (that is, the long axis direction of the toner particle is closer to the direction orthogonal to the surface of an intermediate transfer member, compared to the direction parallel with the surface of the intermediate transfer member) due to an electric field (primary transfer electric field), in a step of transferring a toner image to the intermediate transfer member (primary transfer step). It is considered that the brilliant pigment contained in the toner particle is polarized due to electrostatic induction caused by the primary transfer electric field.

Hereinafter, as an example, a state where the toner and the image holding member are negatively charged and a polarity of the electric field (primary transfer electric field) applied by the primary transfer unit which primarily transfers the toner image from the image holding member to the intermediate transfer member is positive, will be described.

For example, when the polarity of the primary transfer electric field is positive, the negative charges gather on the side nearer to the intermediate transfer member and the positive charges gather on the side farther from the intermediate transfer member, due to the electrostatic induction, in the brilliant pigment contained in the toner particle in the standing-up state on the surface of the intermediate transfer member, and accordingly, the polarization occurs.

In this case, when the A-B average distance is shorter than the range described above, a thickness of a resin layer between the brilliant pigment contained in the toner particle and the surface of the intermediate transfer member decreases, and accordingly, the negative charges gathering on the side near the intermediate transfer member is easily injected to the intermediate transfer member. When the injection of the negative charges occurs, the entire toner particle is in a state having the small number of negative charges (low charged state) or in a state of being positively charged (reverse polarized state), and therefore, an electrostatic adhesion force to the surface of the intermediate transfer member decreases.

Meanwhile, in the intermediate transfer member to which the toner image is transferred, the negative charges are polarized to the front side of the intermediate transfer member (side of the surface which contacts the toner image) and the positive charges are polarized to the rear side of the intermediate transfer member (side opposite to the surface which contacts the toner image), due to the primary transfer electric field. After that, when the charges on the surface of the rear side of the intermediate transfer member are erased by an intermediate transfer member charge erasing unit, the negative charges remain on the surface of the front side of the intermediate transfer member, and accordingly, the toner particle in the low charged state or the reverse polarized state is easily electrostatically adhered to the surface of the intermediate transfer member after the charge is erased. The toner particles on the upstream side of the intermediate transfer member charge erasing unit in a travelling direction of the intermediate transfer member are drawn and scattered to the surface of the intermediate transfer member on the downstream side of the intermediate transfer member charge erasing unit in the travelling direction, and accordingly a defective toner image is generated. Particularly, in a case where the upstream side of the intermediate transfer member charge erasing unit in the travelling direction is an image portion and the downstream side of the intermediate transfer member charge erasing unit in the travelling direction is a non-image portion, the defective toner image is significantly generated when the scattering of the toner particles occurs.

With respect to this, in the exemplary embodiment, the A-B average distance is in the range described above. Accordingly, the resin layer between the brilliant pigment contained in the toner particle and the surface of the intermediate transfer member is thick and the injection of the negative charges hardly occurs, compared to a case where the A-B average distance is shorter than the range described above. Therefore, it is presumed that the defective toner image caused by the scattering of the toner particles may be prevented.

Hereinabove, the state where the toner and the image holding member are negatively charged and the polarity of the primary transfer electric field is positive has been described as an example, but there is no limitation to this state, and the toner and the image holding member may be positively charged and the polarity of the primary transfer electric field may be negative.

In the exemplary embodiment, since the A-B average distance is in the range described above, an image having a high brilliant property is obtained, compared to a case where the A-B average distance is longer than the range described above. The reason thereof is not clear, but it is presumed that, in a fixed image after being fixed to a recording medium, the toner particles are arranged to be tilted, a rate (density) of a region with the visible brilliant pigment in the image is high, and an image having a high brilliant property is obtained, in a case of the short A-B average distance.

The A-B average distance is more preferably from 1.3 μm to 2.7 μm and even more preferably from 1.5 μm to 2.5 μm.

Both of the distance between the tangent line A and the tangent line B of the one end of the toner particle and the distance between the tangent line A and the tangent line B of the other end of the toner particle are preferably in the range described above.

The expression “the toner particles have a flake shape” in the exemplary embodiment means that a value of C is smaller than a value of D, wherein the D (μm) represents an average diameter of equivalent circle diameters (hereinafter, referred to as an “average equivalent circle diameter” in some cases) of maximum projection areas of the toner particles (hereinafter, referred to as a “flake shape surface” in some cases) and C represents an average length (μm) of maximum lengths of thicknesses orthogonal to the maximum projection areas of the toner particles (hereinafter, referred to as an “average maximum thickness” in some cases).

Herein, the average maximum thickness C and the average equivalent circle diameter D of the toner particles are measured with the following method.

The toner is applied to a smooth surface and is dispersed with vibration so as not to have unevenness. 1000 toner particles are observed with a color laser microscope “VK-9700” (manufactured by Keyence Corporation) with a magnification power of 1000, the maximum thickness C and the equivalent circle diameter D of a top view are measured, and arithmetic average values thereof are calculated to obtain the average maximum thickness C and the average equivalent circle diameter D.

In the same manner as in the case of the toner particles, the expression “the brilliant pigment has a flake shape” in the exemplary embodiment means that the average maximum thickness C is smaller than the average equivalent circle diameter D.

The observation of the average maximum thickness C and the average equivalent circle diameter D of the brilliant pigment is also performed in the same manner as in the case of the toner particles, the maximum thickness C and the equivalent circle diameter D of a top view of the brilliant pigment contained in the toner particles are measured, and arithmetic average values thereof are calculated to obtain the average maximum thickness C and the average equivalent circle diameter D.

The “brilliant property” in the exemplary embodiment means that brilliance such as metallic gloss is exhibited when the formed image is observed.

As an image having a brilliant property, an image in which a ratio (X/Y) of a reflectance X at a light receiving angle of +30° and a reflectance Y at a light receiving angle of −30°, measured with the image which is irradiated with incident light at an angle of incidence of −45° by a goniophotometer, is from 2 to 100, is exemplified.

The value of the ratio (X/Y) which is equal to or more than 2 represents that the reflectance at the side opposite the incident light (side of the positive light receiving angle) is greater than the reflectance at the side of the incident light (side of the negative light receiving angle) and diffuse reflection of the incident light is prevented. In a case where the diffuse reflection that incident light is reflected to in various directions occurs, the color appears to be darkened when visually observing the reflected light thereof. Accordingly, when the ratio (X/Y) is equal to or more than 2, the gloss is confirmed when visually observing the reflected light thereof and the excellent brilliant property is obtained.

Meanwhile, if the ratio (X/Y) is equal to or less than 100, a visible angle with which the reflected light may be visually observed is not excessively narrow, and accordingly, a phenomenon in which the color appears to be darkish depending on an angle is unlikely to occur.

The ratio (X/Y) described above is more preferably from 20 to 90 and particularly preferably from 40 to 80.

Measurement of Ratio (X/Y) with Goniophotometer

Herein, first the angle of incidence and the light receiving angle will be described. When measuring the ratio with a goniophotometer in the exemplary embodiment, the angle of incidence is set to −45°, and this is because high measurement sensitivity is obtained with respect to an image with a wide range of glossiness.

In addition, the light receiving angle is set to −30° and to +30° because the measurement sensitivity is highest when evaluating an image with a brilliant property and an image with no brilliant property.

Next, a method of measuring the ratio (X/Y) will be described.

In the exemplary embodiment, when measuring the ratio (X/Y), first, a “solid image” is formed with the following method. A developing device of a DOCUCENTRE-III C7600 manufactured by Fuji Xerox Co., Ltd. is filled with a developer that is a sample, and a solid image having a toner applied amount of 4.5 g/cm² is formed on a recording sheet (OK TOPCOAT+, manufactured by Oji Paper Co., Ltd.) at a fixing temperature of 190° C. and a fixing load of 4.0 kg/cm². The “solid image” indicates an image having a printing rate of 100%.

An image part of the formed solid image is irradiated with the incident light at an angle of incidence of −45° with respect to the solid image, and a reflectance X at a light receiving angle of +30° and a reflectance Y at a light receiving angle of −30° are measured by using a spectral varied angle color-difference meter GC5000L manufactured by Nippon Denshoku Industries Co., Ltd as a goniophotometer. Each of the reflectance X and the reflectance Y is measured with light having a wavelength of 400 nm to 700 nm at intervals of 20 nm, and defined as an average of the reflectances at respective wavelengths. The ratio (X/Y) is calculated from these measurement results.

From the viewpoint of satisfying the above-described ratio (X/Y), the brilliant toner according to the exemplary embodiment preferably satisfies the following requirements (1) or (2).

(1) The toner particles have an average equivalent circle diameter D longer than an average maximum thickness C.

(2) When cross sections of toner particles in a thickness direction are observed, a rate of a brilliant pigment in a range where an angle between a long axis direction of the toner particles in the cross section and a long axis direction of the brilliant pigment is from −30° to +30° is 60% or greater with respect to the total brilliant pigments that are observed.

Herein, FIG. 2 shows a cross-sectional view schematically showing an example of toner particles satisfying the requirements (1) or (2) described above. The schematic view shown in FIG. 2 is a cross-sectional view of the toner particles in a thickness direction thereof.

A toner particle 2 shown in FIG. 2 is a flake shape toner particle having an equivalent circle diameter larger than a thickness L, and contains flake shape (flaky) brilliant pigments 4.

In the exemplary embodiment, it is considered that the flake shape toner particles are arranged so that the flake shape surface sides thereof face the surface of the recording medium (in a direction close to the parallel direction) due to the physical pressure from the fixing member in the fixing step.

Therefore, it is considered that among the flake shape brilliant pigments contained in the toner particle, the brilliant pigment that satisfies that “an angle between a long axis direction of the toner in the cross section and a long axis direction of the brilliant pigment particle is from −30° to +30° ” described in the requirement (2) are arranged so that the surface side that provides the maximum area faces the surface of the recording medium (in a direction close to the parallel direction). When the image formed in this manner is irradiated with light, the rate of the brilliant pigment particles that causes diffuse reflection of the incident light is suppressed, and thus it is considered that the above-described range of the ratio (X/Y) is easily achieved.

Hereinafter, the toner according to the exemplary embodiment will be described in detail.

The toner according to the exemplary embodiment includes the toner particles and, if necessary, external additives.

Toner Particles

The toner particles are configured to include, for example, a binder resin and a flake shape brilliant pigment, and if necessary, may include a release agent and other additives.

Brilliant Pigment

Examples of the brilliant pigment include metal powders such as aluminum, brass, bronze, nickel, stainless steel, or zinc; mica on which titanium oxide or yellow iron oxide is coated; a coated laminar inorganic crystal substrate such as barium sulfate, layered silicate, or silicate of layered aluminum; single crystal plate-shaped titanium oxide; basic carbonate; acid bismuth oxychloride; natural guanine; laminar glass powder; and laminar glass powder which is subjected to metal vapor deposition, and there is no particular limitation as long it is a pigment having as the brilliant property. The brilliant pigments may be used alone or in combination with two or more kinds thereof.

Among the brilliant pigments, the metal pigment such as the metal powder is preferable particularly from a viewpoint of mirror reflection intensity, and aluminum is most preferable among these, particularly from a viewpoint of availability and flake shape of the toner particles.

When the metallic pigment is used as the brilliant pigment, it is considered that the injection of the charges to the intermediate transfer member from the toner particles particularly easily occurs, compared to a case of using the other brilliant pigments. However, it is considered that in the exemplary embodiment, since the A-B average distance is in the range described above, the injection of the charge is prevented, and the image defect derived from the scattering of the toner particles due to the injection of charges is prevented.

The volume resistivity of the brilliant pigment is, for example, less than 10⁷ Ω·cm, is preferably from 1×10⁻⁴ Ω·cm to 1×10² Ω·cm, and more preferably from 1×10⁻³ Ω·cm to 1×10⁻² Ω·cm.

The content of the brilliant pigment in the toner particles is, for example, preferably from 1 part by weight to 70 parts by weight and more preferably from 5 parts by weight to 50 parts by weight, with respect to 100 parts by weight of the binder resin which will be described later.

As described above, the brilliant pigment has a flake shape.

The value of the ratio (C/D) of the brilliant pigment is preferably from 0.005 to 0.700, more preferably from 0.005 to 0.1, and even more preferably from 0.01 to 0.1. When the ratio (C/D) of the brilliant pigment is equal to or greater than 0.005, it is advantageous because the strong resistance is obtained with respect to stirring stress when granulating the toner. In addition, when the ratio (C/D) of the brilliant pigment is equal to or smaller than 0.700, a high brilliant property is easily obtained, compared to a case where the ratio thereof is greater than 0.700.

Binder Resin

Examples of the binder resins include a vinyl resin formed of homopolymer consisting of monomers such as styrenes (for example, styrene, p-chlorostyrene, α-methyl styrene, or the like), (meth)acrylic esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, or the like), ethylenic unsaturated nitriles (for example, acrylonitrile, methacrylonitrile, or the like), vinyl ethers (for example, vinyl methyl ether, vinyl isobutyl ether, or the like), vinyl ketones (for example, vinyl methyl ketone, vinyl ethyl ketone, vinyl isopropenyl ketone, or the like), olefins (for example, ethylene, propylene, butadiene, or the like), or a copolymer obtained by combining two or more kinds of these monomers.

Examples of the binder resin also include a non-vinyl resin such as an epoxy resin, a polyester resin, a polyurethane resin, a polyamide resin, a cellulose resin, apolyether resin, and a modified rosin, a mixture of these and the vinyl resin, or a graft polymer obtained by polymerizing a vinyl monomer in the presence of these.

These binder resins may be used alone or in combination with two or more kinds thereof.

As the binder resin, a polyester resin is preferably used.

As the polyester resin, a well-known polyester resin is used, for example.

Examples of the polyester resin include polycondensates of polyvalent carboxylic acids and polyols. A commercially available product or a synthesized product may be used as the polyester resin.

Examples of the polyvalent carboxylic acid include aliphatic dicarboxylic acids (e.g., oxalic acid, malonic acid, maleic acid, fumaric acid, citraconic acid, itaconic acid, glutaconic acid, succinic acid, alkenyl succinic acids, adipic acid, and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (e.g., ethylene glycol, diethylene glycol, triethylene glycol, propylene glycol, butanediol, hexanediol, and neopentyl glycol), alicyclic dials (e.g., cyclohexanediol, cyclohexanedimethanol, and hydrogenated bisphenol A), and aromatic dials (e.g., ethylene oxide adducts of bisphenol A and propylene oxide adducts of bisphenol A). Among these, for example, aromatic dials and alicyclic diols are preferably used, and aromatic dials are more preferably used as the polyol.

As the polyol, a tri- or higher-valent polyol employing a crosslinked structure or a branched structure may be used in combination with a diol. Examples of the tri- or higher-valent polyol include glycerin, trimethylolpropane, and pentaerythritol.

The polyols may be used alone or in combination of two or more kinds thereof.

The glass transition temperature (Tg) of the polyester resin is preferably from 50° C. to 80° C., and more preferably from 50° C. to 65° C.

The glass transition temperature is obtained by a DSC curve obtained by differential scanning calorimetry (DSC). More specifically, the glass transition temperature is obtained by “extrapolating glass transition starting temperature” disclosed in a method of obtaining the glass transition temperature of JIS K7121-1987 “Testing Methods for Transition Temperatures of Plastics”.

A weight average molecular weight (Mw) of the polyester resin is preferably from 5,000 to 1,000,000, and more preferably from 7,000 to 500,000.

A number average molecular weight (Mn) of the polyester resin is preferably from 2,000 to 100,000.

A molecular weight distribution Mw/Mn of the polyester resin is preferably from 1.5 to 100, and more preferably from 2 to 60.

The weight average molecular weight and the number average molecular weight are measured by gel permeation chromatography (GPC). The molecular weight measurement by GPC is performed with a THF solvent using HLC-8120 GPC which is a GPC manufactured by Tosoh Corporation as a measurement device and a TSKGEL SUPER HM-M (15 cm) which is a column manufactured by Tosoh Corporation. The weight average molecular weight and the number average molecular weight are calculated from results of this measurement using a calibration curve of molecular weights created with monodisperse polystyrene standard samples.

The polyester resin is obtained with a well-known preparing method. Specific examples thereof include a method of conducting a reaction at a polymerization temperature set to 180° C. to 230° C., if necessary, under reduced pressure in the reaction system, while removing water or alcohol generated during condensation.

When monomers of the raw materials do not dissolve or become compatibilized at a reaction temperature, a high-boiling-point solvent may be added as a solubilizing agent to dissolve the monomers. In this case, a polycondensation reaction is conducted while distilling away the solubilizing agent. When a monomer having poor compatibility is present in a copolymerization reaction, the monomer having poor compatibility and an acid or an alcohol to be polycondensed with the monomer may be previously condensed and then polycondensed with a major component.

The content of the binder resin is, for example, preferably from 40% by weight to 95% by weight, more preferably from 50% by weight to 90% by weight, and even more preferably from 60% by weight to 85% by weight, with respect to the entire toner particles.

Release Agent

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited thereto.

The melting temperature of the release agent is preferably from 50° C. to 110° C., and more preferably from 60° C. to 100° C.

The melting temperature of the release agent is obtained from “melting peak temperature” described in the method of obtaining a melting temperature in JIS K7121-1987 “Testing Methods for Transition Temperatures of Plastics”, from a DSC curve obtained by differential scanning calorimetry (DSC).

The content of the release agent is, for example, preferably from 1% by weight to 20% by weight and more preferably from 5% by weight to 15% by weight, with respect to the entirety of the toner particles.

Other Additives

Examples of other additives include known additives such as a magnetic material, a charge-controlling agent, and an inorganic powder. The toner particles contain these additives as internal additives.

In addition, as the other additives, the other colorant other than the brilliant pigment may be included. As the other colorant, a well-known colorant is used, and the colorant is selected depending on a desirable color.

Characteristics of Toner Particles

The toner particles may be toner particles having a single-layer structure, or toner particles having a so-called core/shell structure composed of a core (core particle) and a coating layer (shell layer) coated on the core.

Here, toner particles having a core/shell structure are preferably composed of, for example, a core containing a binder resin, and if necessary, other additives such as a colorant and a release agent, and a coating layer containing a binder resin.

Average Maximum Thickness C and Average Equivalent Circle Diameter D of Toner Particles

As described above, the toner particles have a flake shape. That is, the value of the average maximum thickness C is smaller than the value of the average equivalent circle diameter D.

In addition, the value of the ratio (C/D) of the toner particles is preferably equal to or smaller than 0.700, more preferably from 0.005 to 0.500, even more preferably from 0.010 to 0.200, and particularly preferably from 0.050 to 0.100. When the ratio (C/D) is 0.005 or greater, toner particle strength is obtained and a fracture that is caused due to a stress in the image formation is thus prevented, whereby a reduction in charges that is caused by exposure of the pigment from the toner particles, and fogging that is caused as a result thereof is prevented. Meanwhile, when the ratio (C/D) is equal to or smaller than 0.700, a high brilliant property is easily obtained, compared to a case where the ratio thereof is greater than 0.700.

Angle Between Long Axis Direction of Toner Particles in Cross Section and Long Axis Direction of Brilliant Pigment Particles

As shown in the requirement (2), when cross sections of toner particles in a thickness direction are observed, the rate (based on the number) of the brilliant pigment that are present so that an angle between a long axis direction of the toner particles in the cross section and a long axis direction of the brilliant pigment is from −30° to +30° is preferably 60% or greater of the total number of brilliant pigment that are observed. Furthermore, the rate is more preferably from 70% to 95%, and particularly preferably from 80% to 90% of the total number of brilliant pigment particles.

When the rate described above is equal to or greater than 60%, an excellent brilliant property is obtained.

Herein, the observation method of the cross sections of toner particles will be described.

Toner is embedded using a bisphenol A type epoxy resin and a hardening agent, and then a cut sample is prepared. Then, the cut sample is cut by using a cutter using a diamond knife (using LEICA ULTRAMICROTOME (manufactured by Hitachi High-Technologies Corporation) in the exemplary embodiment) at −100° C., and an observation sample is prepared. With this observation sample, the cross sections of the toner particles are observed using a transmission electron microscope (TEM) at a magnification of about 5000-fold. With the observed 1000 toners particles, the number of brilliant pigments in which the angle between the long axis direction of the toner particles in cross section and the long axis direction of the brilliant pigment is from −30° C. to +30° C., is counted using image analysis software, and the proportion thereof is calculated.

The “long axis direction of the toner particles in the cross section” indicates a direction perpendicular to the thickness direction of the toner particles having the average equivalent circle diameter D larger than the average maximum thickness C. The “long axis direction of the brilliant pigment” indicates a length direction of the brilliant pigment.

Volume Average Particle Diameter of Toner Particles

The volume average particle diameter of the toner particles is preferably from 1 μm to 30 μm, more preferably from 3 μm to 20 μm, and particularly preferably from 8 μm to 20 μm. When the toner particles have a flake shape as in the toner particles of the exemplary embodiment, the value of the volume average particle diameter represents a volume average value of an equivalent spherical size.

In detail, regarding the volume average particle diameter D₅₀ᵥ, cumulative distributions by volume and by number are drawn from the side of the smallest size on the basis of particle size ranges (channels) separated based on the particle size distribution measured by a measuring machine such as a MULTISIZER II (manufactured by Beckman Coulter Inc.). The particle diameter when the cumulative percentage becomes 16% is defined as that corresponding to a volume D₁₆ᵥ and a number D₁₆ₚ, while the particle diameter when the cumulative percentage becomes 50% is defined as that corresponding to a volume D₅₀ᵥ and a number D₅₀ₚ. Furthermore, the particle diameter when the cumulative percentage becomes 84% is defined as that corresponding to a volume D₈₄ᵥ and a number D₈₄ₚ. Using these, a volume average particle size distribution index (GSDv) is calculated as (D₈₄ᵥ/D₁₆ᵥ)^{1/2}.

External Additives

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

Surfaces of the inorganic particles as an external additive are preferably subjected to a hydrophobizing treatment. The hydrophobizing treatment is performed by, for example, dipping the inorganic particles in a hydrophobizing agent. The hydrophobizing agent is not particularly limited and examples thereof include a silane coupling agent, silicone oil, a titanate coupling agent, and an aluminum coupling agent. These may be used alone or in combination of two or more kinds thereof.

Generally, the amount of the hydrophobizing agent is, for example, from 1 part by weight to 10 parts by weight with respect to 100 parts by weight of the inorganic particles.

Examples of the external additive also include resin particles (resin particles such as polystyrene, PMMA, and melamine resin particles) and a cleaning aid (e.g., metal salt of a higher fatty acid represented by zinc stearate, and fluorine-based polymer particles).

The amount of the external additives externally added is, for example, preferably from 0.01% by weight to 5% by weight, and more preferably from 0. 01% by weight to 2.0% by weight with respect to the toner particles.

Preparing Method of Toner

Next, a method of preparing a toner according to the exemplary embodiment will be described.

The toner according to the exemplary embodiment is obtained by externally adding an external additive to toner particles after preparation of the toner particles.

As a method of preparing the toner particle having the A-B average distance in the range described above, the following methods (1) to (3) are used, for example.

(1): A method of preparing the toner particle having the A-B average distance in the range described above, the method including: a step of preparing mixed dispersion by adding the brilliant pigment to a dispersion (hereinafter, referred to as “first particle dispersion” in some cases) containing aggregates (hereinafter, referred to as “first aggregated particles” in some cases) in which the particles of the binder resin are aggregated; a step of forming aggregates (hereinafter, referred to as “second aggregated particles” in some cases) in which the first aggregated particles and the brilliant pigment are aggregated; and a step of coalescing of the second aggregated particles.

(2): A method of preparing the toner particle having the A-B average distance in the range described above, the method including: a step of adding the first particle dispersion to dispersion (hereinafter, referred to as “third particle dispersion” in some cases) containing aggregates (hereinafter, referred to as “third aggregated particles” in some cases) containing the particles of the binder resin and the brilliant pigment; a step of forming aggregate (hereinafter, referred to as “fourth aggregated particles” in some cases) in which the first aggregated particles and the third aggregated particles are aggregated; and a step of coalescing the fourth aggregated particles.

(3): A method of preparing the toner particle having the A-B average distance in the range described above, the method including: a step of mixing particles of the binder resin (hereinafter, referred to as “fifth resin particles” in some cases) and particles containing the binder resin and the brilliant pigment (hereinafter, referred to as “sixth toner particles in some cases) with each other, and mechanically adhering the fifth resin particles to the sixth toner particles.

A volume average particle diameter of the first aggregated particles is, for example, from 1 μm to 3 μm, preferably from 1.3 μm to 2.7 μm, and more preferably from 1.5 μm to 2.5 μm.

A volume average particle diameter of the fifth resin particles is, for example, from 0.5 μm to 3 μm, preferably from 1.0 μm to 2.3 μm, and more preferably from 1.2 μm to 2.0 μm.

Among the methods (1) to (3) described above, the method (2) is used, for example, as a method for easily obtaining the longer A-B average distance.

All of the first aggregated particles, the second aggregated particles, the third aggregated particles, the fourth aggregated particles, the fifth resin particles, and the sixth toner particles may contain a release agent or other additives, if necessary.

In the method (1) or (2) described above, for example, the fifth resin particles used in the method (3) described above may be used, instead of the first aggregated particles or with the first aggregated particles (that is, dispersion containing the fifth resin particles may be used as the first particle dispersion).

In the method (2), for example, the sixth toner particles used in the method (3) described above may be used, instead of the third aggregated particles or with the third aggregated particles (that is, dispersion containing the sixth toner particles may be used as the third particle dispersion).

Hereinafter, the methods (1) to (3) described above will be described in detail.

Method (1)

In the method (1), for example, first, the resin particle dispersion in which particles of the binder resin are dispersed is prepared, the particles of the binder resin are aggregated in the resin particle dispersion, the first aggregated particles are formed (that is, aggregation is continued until the aggregates of the particles have a target volume average particle diameter), and accordingly, the first particle dispersion is obtained.

Brilliant pigment dispersion containing the particles of the brilliant pigment is added to the first particle dispersion in an aggregation step and aggregation is further conducted to form aggregates (the second aggregated particles) containing the first aggregated particles and the particles of the brilliant pigment, coalescence of the second aggregated particles is coalesced, and the toner particles are obtained.

Preparation of First Particle Dispersion

As described above, the first particle dispersion is obtained by aggregating the particles of the binder resin in the resin particle dispersion, for example.

Herein, the resin particle dispersion is prepared by, for example, dispersing resin particles by a surfactant in a dispersion medium.

Examples of the dispersion medium used for the resin particle dispersion include aqueous mediums.

Examples of the aqueous mediums include water such as distilled water and ion exchange water, and alcohols. These maybe used alone or in combination of two or more kinds thereof.

Examples of the surfactant include anionic surfactants such as sulfate ester salt, sulfonate, phosphate, and soap-based anionic surfactants; cationic surfactants such as amine salt and quaternary ammonium salt cationic surfactants; and nonionic surfactants such as polyethylene glycol, alkylphenol ethylene oxide adduct, and polyol nonionic surfactants. Among these, anionic surfactants and cationic surfactants are particularly used. Nonionic surfactants may be used in combination with anionic surfactants or cationic surfactants.

The surfactants may be used alone or in combination of two or more kinds thereof.

Regarding the resin particle dispersion, as a method of dispersing the resin particles in the dispersion medium, a common dispersing method using, for example, a rotary shearing-type homogenizer, or a ball mill, a sand mill, or a DYNO MILL having media is exemplified. Depending on the kind of the resin particles, resin particles may be dispersed in the resin particle dispersion using, for example, a phase inversion emulsification method.

The phase inversion emulsification method includes: dissolving a resin to be dispersed in a hydrophobic organic solvent in which the resin is soluble; performing neutralization by adding abase to an organic continuous phase (O phase); and converting the resin (so-called phase inversion) from W/O to O/W by adding an aqueous medium (W phase) to form a discontinuous phase, thereby dispersing the resin as particles in the aqueous medium.

The volume average particle diameter of the resin particles dispersed in the resin particle dispersion is, for example, preferably from 0.01 μm to 1 μm, more preferably from 0.08 μm to 0.8 μm, and even more preferably from 0.1 μm to 0.6 μm.

Regarding the volume average particle diameter of the resin particles, a cumulative distribution by volume is drawn from the side of the smallest size with respect to particle size ranges (channels) separated using the particle size distribution obtained by the measurement with a laser diffraction-type particle size distribution measuring device (for example, LA-700, manufactured by Horiba, Ltd.), and a particle diameter when the cumulative percentage becomes 50% with respect to the entirety of the particles is measured as a volume average particle diameter D50v. The volume average particle diameter of the particles in other dispersions is also measured in the same manner.

The content of the resin particles contained in the resin particle dispersion is, for example, preferably from 5% by weight to 50% by weight, and more preferably from 10% by weight to 40% by weight.

Specifically, as a method of aggregating the resin particles in the resin particle dispersion, an aggregating agent is added to the resin particle dispersion and a pH of the resin particle dispersion is adjusted to acidity (for example, the pH being from 2 to 5). If necessary, a dispersion stabilizer is added. Then, the resin particle dispersion is heated at a temperature of the glass transition temperature of the binder resin (specifically, for example, from a temperature 30° C. lower than the glass transition temperature of the binder resin to a temperature 10° C. lower than the glass transition temperature thereof).

When forming the aggregates, for example, the aggregating agent may be added at room temperature (for example, 25° C.) under stirring of the resin particle dispersion using a rotary shearing-type homogenizer, the pH of the resin particle dispersion may be adjusted to acidity (for example, the pH being from 2 to 5), a dispersion stabilizer may be added if necessary, and the heating may then be performed.

Examples of the aggregating agent include a surfactant having an opposite polarity to the polarity of the surfactant used as the dispersing agent added to the resin particle dispersion, such as inorganic metal salts and di- or higher-valent metal complexes. Particularly, when a metal complex is used as the aggregating agent, the amount of the surfactant used is reduced and charging characteristics are improved.

If necessary, an additive may be used to form a complex or a similar bond with the metal ions of the aggregating agent. A chelating agent is preferably used as the additive.

Examples of the inorganic metal salts include metal salts such as calcium chloride, calcium nitrate, barium chloride, magnesium chloride, zinc chloride, aluminum chloride, and aluminum sulfate, and inorganic metal salt polymers such as polyaluminum chloride, polyaluminum hydroxide, and calcium polysulfide.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably from 0.01 parts by weight to 5.0 parts by weight, and more preferably from 0.1 parts by weight to less than 3.0 parts by weight with respect to 100 parts by weight of the resin particles.

As a method of controlling the volume average particle diameter of the first aggregated particles, a method of adjusting the heating time of the binder resin at the glass transition temperature is used, for example.

When the first aggregated particles contain the release agent, release agent dispersion containing particles of the release agent is prepared, in addition to the resin particle dispersion, for example, and the particles of the binder resin and the particles of the release agent are aggregated in mixed of the resin particle dispersion and the release agent dispersion.

In the preparation of a release agent dispersion, a release agent is dispersed in water, together with an ionic surfactant or a polymer electrolyte such as a polymer acid or a polymer base, and then a dispersion treatment is performed using a homogenizer or a pressure discharge-type dispersing machine with which a strong shear force is applied thereto, simultaneously with heating at a temperature that is not lower than the melting temperature of the release agent. The release agent dispersion is obtained through such a treatment. In the dispersion treatment, an inorganic compound such as polyaluminum chloride may be added to the dispersion. Examples of the preferable inorganic compound include polyaluminum chloride, aluminum sulfate, highly basic polyaluminum chloride (BAC), polyaluminum hydroxide, and aluminum chloride. Among these, polyaluminum chloride, aluminum sulfate, and the like are preferable.

Through the dispersion treatment, a release agent dispersion containing release agent particles having a volume average particle diameter of 1 μm or less is obtained. More preferably, the volume average particle diameter of the release agent particles is from 100 nm to 500 nm.

When the volume average particle diameter is 100 nm or greater, the characteristics of the binder resin to be used are also affected, but generally, the release agent component is easily incorporated in the toner. When the volume average particle diameter is 500 nm or less, the release agent in the toner has a superior dispersion state.

Formation and Coalescence of Second Aggregated Particles

In order to prepare brilliant pigment dispersion to be added to the first particle dispersion, a known dispersion method may be used and a general dispersion unit such as a rotary shearing-type homogenizer, a ball mill, a sand mill, a DYNO mill having media, or an ULTIMIZER may be employed. The brilliant pigment is dispersed in water, together with an ionic surfactant or a polymer electrolyte such as a polymer acid or a polymer base. The volume average particle diameter of the dispersed brilliant pigment may be 20 μm or less. The volume average particle diameter is preferably from 3 μm to 16 μm, since the brilliant pigment is dispersed well in the toner particles with no impairment in aggregation property.

As a method of adding the brilliant pigment to the first particle dispersion, as described above, the brilliant pigment dispersion may be prepared and then added thereto, or the commercially available brilliant pigment or brilliant pigment dispersion may be added as it is.

When the toner particles contain the release agent or other additives, in addition to the binder resin and the brilliant pigment, the mixed dispersion is obtained by adding the release agent or other additives in addition to the brilliant pigment, to the first particle dispersion. When adding the release agent, the release agent may be added as the release agent dispersion containing the particles of the release agent.

When forming the second aggregated particles, for example, the aggregating agent is added to the mixed dispersion obtained by the addition of the brilliant pigment or the like, a pH of the mixed dispersion is adjusted to acidity while stirring, and the heating is performed at a temperature equal to or lower than the glass transition temperature of the binder resin. Accordingly, the first aggregated particles and the particles of the brilliant pigment (if necessary, with particles of the release agent) are aggregated in the mixed dispersion, and the second aggregated particles are formed.

As the aggregating agent, the same aggregating agent as that used for preparing the first aggregated particles is used.

However, when forming the second aggregated particles, the inorganic metal salt such as aluminum salts and polymers thereof are particularly preferably used as the aggregating agent. In order to obtain a narrower particle size distribution, the valence of the inorganic metal salt is more preferably divalent than monovalent, trivalent than divalent, or tetravalent than trivalent, and further, in the case of the same valences as each other, a polymer-type inorganic metal salt polymer is more suitable.

As the aggregating agent, a polymer of tetravalent inorganic metal salt including aluminum is preferably used to obtain a narrow particle size distribution.

By adjusting of the above stirring conditions, the ratio (C/D) of the toner particles is easily controlled. More specifically, in the second aggregated particle forming stage, when the stirring speed is increased and heating is performed at a higher temperature, the ratio (C/D) may be reduced, and when the stirring speed is reduced and the heating is performed at a lower temperature, the ratio (C/D) may be increased. The pH is preferably from 2 to 7.

In addition, when the aggregated particles in the mixed dispersion havea desired particle diameter, the resin particle dispersion may be further added (coating step) to obtain a configuration in which a surface of a core aggregated particle is coated with a resin. In this case, the release agent or the brilliant pigment is not easily exposed to the toner particle surface, and thus the configuration is preferable from the viewpoint of charging property or developing property. In the case of further addition, an aggregating agent may be added or the pH may be adjusted before further addition.

In a step of coalescing the second aggregated particles, the progression of the aggregation is stopped by increasing the pH of the suspension of the second aggregated particles to the range of 3 to 9 under stirring conditions based on the step of forming the second aggregated particles, and the heating is performed at a temperature that is not lower than the glass transition temperature of the binder resin.

In addition, in the case of coating with the resin, the resin is also coalesced and the core aggregated particles are coated therewith.

Regarding the heating time, the heating may be performed to the extent that the coalescence is caused, and may be performed for 0.5 hours to 10 hours.

After the coalescence, cooling is performed to obtain toner particles. In addition, in the cooling step, crystallization may be promoted by lowering the cooling rate at around the glass transition temperature of the resin (glass transition temperature±10° C.), that is, so-called slow cooling.

The coalesced toner particles may be subjected to a solid-liquid separation step such as filtration, and if necessary, a washing step and a drying step.

When preparing the toner particles by the method (1) described above, as a method of controlling the A-B average distance, a method of setting an aggregation temperature in the step of aggregating the first aggregated particles to be from a temperature 10° C. lower than the glass transition temperature of the binder resin to a temperature 5° C. lower than the glass transition temperature thereof is used, for example.

Method (2)

In the method (2), for example, first, the third aggregated particles are formed by the same method as a well-known aggregation method, as the preparation method of the toner particles. Specifically, the dispersion of the particles of the materials configuring the toner particles (the resin particle dispersion, the brilliant pigment dispersion, and if necessary, the release agent dispersion) are prepared and mixed with each other, the particles are aggregated in the mixed dispersion, the third aggregated particles are formed, and accordingly, the third particle dispersion is obtained.

The first particle dispersion obtained by the process of preparing the toner particles by the method (1) is added to the third particle dispersion in the aggregation step and aggregation is continued to form aggregates (the fourth aggregated particles) containing the first aggregated particles and the third aggregated particles, the fourth aggregated particles is coalesced, and the toner particles are obtained.

Preparation of Third Particle Dispersion

The preparation method of the resin particle dispersion, the brilliant pigment dispersion, and the release agent dispersion is as described above. The resin particle dispersion, the brilliant pigment dispersion, and if necessary, the release agent dispersion and other additives are mixed with each other, and accordingly, mixed dispersion containing the particles of the materials configuring the toner particles is obtained.

In the step of aggregating the first aggregated particles and the third aggregated particles in the mixed dispersion, the aggregating agent, the stirring speed, the heating temperature, and the pH used are set in the same manner as in the formation of the second aggregated particles.

However, when preparing the third particle dispersion, a volume average particle diameter of the obtained third aggregated particles is preferably a value smaller than a desired volume average particle diameter of the toner particles approximately by 5 μm. The volume average particle diameter of the third aggregated particles is, for example, from 2 μm to 6 μm.

Formation and Coalescence of Fourth Aggregated Particles

In the step of formation and coalescence of the fourth aggregated particles, the types of the aggregating agent, the method of controlling the ratio (C/D) of the toner particles and the like are set in the same manner as in the step of formation and coalescence of the second aggregated particles, except for using the dispersion containing the third particle dispersion and the first particle dispersion (if necessary, the release agent dispersion and other additives), instead of using the mixed dispersion.

The toner particles obtained by the coalescence may be subjected to the cooling step, the solid-liquid separation step, the washing step, and the drying step, in the same manner as in the method (1).

When preparing the toner particles by the method (2) described above, as the method of controlling the A-B average distance, a method of setting the aggregation temperature in the step of aggregating the first aggregated particles to be from a temperature 35° C. lower than the glass transition temperature of the binder resin to a temperature 30° C. lower than the glass transition temperature thereof is used, for example.

Method (3)

As a method of preparing the fifth resin particles, for example, a method of obtaining the fifth resin particles having a desired volume average particle diameter by a well-known phase inversion emulsification method or a kneading and pulverizing method as the preparation method of the toner, is used, in addition to the method of coalescence of the first aggregated particles in the first particle dispersion.

As a method of preparing the sixth toner particles, for example, a method of obtaining the sixth toner particles by a well-known kneading and pulverizing method as the preparation method of the toner, is used, in addition to the method of coalescing the third aggregated particles in the third particle dispersion.

A volume average particle diameter of the sixth toner particles is the same as the volume average particle diameter of the third aggregated particles.

As a method of mechanically adhering the fifth resin particles to the sixth toner particles, a method using a wet grinding mill such as a sample mill is used, for example.

When performing the adhering by the sample mill, specifically, for example, the dried fifth resin particles and sixth toner particles are put in the sample mill and stirred so as to cause the fifth resin particles to collide with the surface of the sixth toner particles, and accordingly the toner particles are obtained. The rotation rate of the stirring is, for example, from 10,000 rpm to 15,000 rpm, and the stirring time is, for example, from 60 seconds to 300 seconds.

When preparing the toner particles by the method (3) described above, as a method of controlling the A-B average distance, a method of setting the stirring time in the stirring step to be from 30 seconds to 60 seconds is used.

By doing so, the toner particle having the A-B average distance in the range described above is obtained.

The toner according to the exemplary embodiment is prepared by, for example, adding and mixing an external additive with dry toner particles that have been obtained. The mixing is preferably performed with, for example, a V-blender, a HENSCHEL MIXER, a LÖDIGE MIXER, or the like. Furthermore, if necessary, coarse toner particles may be removed using a vibration sieving machine, a wind classifier, or the like.

Electrostatic Charge Image Developer

An electrostatic charge image developer according to the exemplary embodiment includes at least the toner according to the exemplary embodiment.

The electrostatic charge image developer according to the exemplary embodiment may be a single-component developer including only the toner according to the exemplary embodiment, or a two-component developer obtained by mixing the toner with a carrier.

The carrier is not particularly limited, and known carriers are exemplified. Examples of the carrier include a coated carrier in which surfaces of cores formed of a magnetic particle are coated with a coating resin; a magnetic particle dispersion-type carrier in which magnetic particles are dispersed and blended in a matrix resin; a resin impregnation-type carrier in which a porous magnetic particle is impregnated with a resin; and a resin dispersion-type carrier in which conductive particles are dispersed and blended in a matrix resin.

The magnetic particle dispersion-type carrier and the resin impregnation-type carrier may be carriers in which constituent particles of the carrier are cores and coated with a coating resin.

Examples of the magnetic particle include magnetic metals such as iron, nickel, and cobalt, and magnetic oxides such as ferrite and magnetite.

Examples of the conductive particles include particles of metals such as gold, silver, and copper, carbon black particles, titanium oxide particles, zinc oxide particles, tin oxide particles, barium sulfate particles, aluminum borate particles, and potassium titanate particles.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured to include an organosiloxane bond or a modified product thereof, a fluororesin, polyester, polycarbonate, a phenol resin, and an epoxy resin.

The coating resin and the matrix resin may contain additives such as a conductive material.

Herein, a coating method using a coating layer forming solution in which a coating resin and, if necessary, various additives are dissolved in an appropriate solvent is used to coat the surface of a core with the coating resin. The solvent is not particularly limited, and may be selected in consideration of the type of coating resin to be used, coating suitability, and the like.

Specific examples of the resin coating method include a dipping method of dipping cores in a coating layer forming solution; a spraying method of spraying a coating layer forming solution onto surfaces of cores; a fluidized bed method of spraying a coating layer forming solution in a state in which cores are allowed to float by flowing air; and a kneader-coater method in which cores of a carrier and a coating layer forming solution are mixed with each other in a kneader-coater and the solvent is removed.

The mixing ratio (weight ratio) between the toner and the carrier in the two-component developer is preferably from 1:100 to 30:100, and more preferably from 3:100 to 20:100 (toner:carrier).

Image Forming Apparatus/Image Forming Method

An image forming apparatus and an image forming method according to the exemplary embodiment will be described.

The image forming apparatus according to the exemplary embodiment is provided with an image holding member, a charging unit that charges a surface of the image holding member, an electrostatic charge image forming unit that forms an electrostatic charge image on a charged surface of the image holding member, a developing unit that accommodates an electrostatic charge image developer and develops the electrostatic charge image formed on the surface of the image holding member with the electrostatic charge image developer to form a toner image, an intermediate transfer member to which the toner image formed on the surface of the image holding member is primarily transferred, a primary transfer unit that primarily transfers the toner image formed on the surface of the image holding member to the surface of the intermediate transfer member, an intermediate transfer member charge erasing unit that erases charges of the intermediate transfer member to which the toner image is primarily transferred, a secondary transfer unit that secondarily transfers the toner image on the surface of the intermediate transfer member erased by the intermediate transfer member charge erasing unit, to a surface of a recording medium, and a fixing unit that fixes the toner image transferred onto the surface of the recording medium. As the electrostatic charge image developer, the electrostatic charge image developer according to the exemplary embodiment is applied.

In the image forming apparatus according to the exemplary embodiment, an image forming method (image forming method according to the exemplary embodiment) including a charging process of charging a surface of an image holding member, an electrostatic charge image forming process of forming an electrostatic charge image on a charged surface of the image holding member, a developing process of developing the electrostatic charge image formed on the surface of the image holding member with the electrostatic charge image developer according to the exemplary embodiment to form a toner image, a primary transfer process of primarily transferring the toner image formed on the surface of the image holding member to the surface of the intermediate transfer member, an intermediate transfer member charge erasing process of erasing charges of the intermediate transfer member to which the toner image is primarily transferred, a secondary transfer process of secondarily transferring the toner image on the surface of the intermediate transfer member erased by an intermediate transfer member charge erasing unit, to a surface of a recording medium, and a fixing process of fixing the toner image transferred onto the surface of the recording medium is performed.

In the image forming apparatus according to the exemplary embodiment, for example, a part including the developing unit may have a cartridge structure (process cartridge) that is detachable from the image forming apparatus. As the process cartridge, for example, a process cartridge that accommodates the electrostatic charge image developer according to the exemplary embodiment and is provided with a developing unit is preferably used.

Hereinafter, an example of the image forming apparatus according to the exemplary embodiment will be described. However, the image forming apparatus is not limited thereto. The major parts shown in the drawing will be described, but descriptions of other parts will be omitted.

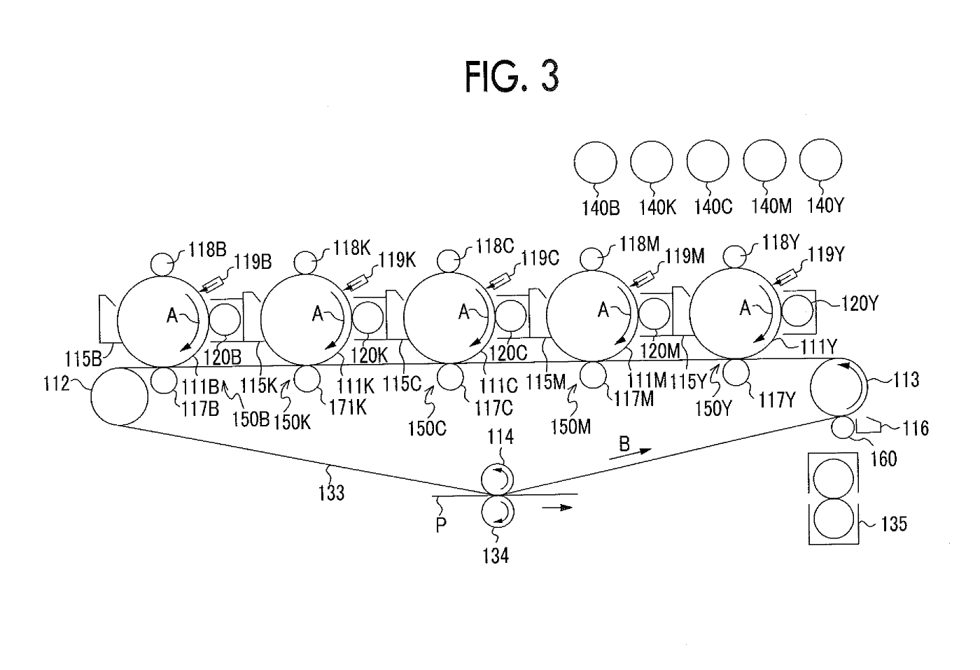

FIG. 3 is a schematic configuration diagram showing the image forming apparatus according to the exemplary embodiment. The image forming apparatus according to the exemplary embodiment has a tandem type configuration in which plural photoreceptors as the image holding member, that is, plural image forming units are provided, and is configured as an image forming apparatus which is an intermediate transfer type including an intermediate transfer belt as the intermediate transfer member.

As shown in FIG. 3, in the image forming apparatus according to the exemplary embodiment, four image forming units 150Y, 150M, 150C, and 150K that forms yellow, magenta, cyan, black toner images, and an image forming unit 150B that forms a metallic toner image using the developer according to the exemplary embodiment are arranged in parallel with each other (in a tandem shape) at intervals. The image forming units 150B, 150K, 150C, 150M, and 150Y are arranged in this order, from the downstream side in a rotation direction of an intermediate transfer belt 133.

Herein, since the image forming units 150Y, 150M, 150C, 150K, and 150B have the same configurations except for the color of the toner in the accommodated developer, the image forming unit 150Y that forms a yellow image will be described as a representative, herein. The description of the image forming units 150M, 150C, 150K, and 150B is omitted by using the reference numerals of magenta (M), cyan (C), black (K), and metallic (B), instead of yellow (Y), in the same part of the image forming unit 150Y.

The yellow image forming unit 150Y includes a photoreceptor 111Y as an image holding member, and this photoreceptor 111Y is rotatably driven at a predetermined process speed by a driving unit (not shown) along an arrow A direction shown in the drawing. As the photoreceptor 111Y, an organic photoreceptor having sensitivity in an infrared region is used, for example.

A charging roll (charging unit) 118Y is provided over the photoreceptor 111Y, a predetermined voltage is applied to the charging roll 118Y by a power supply (not shown), and the surface of the photoreceptor 111Y is charged to a predetermined potential.

Around the photoreceptor 111Y, an exposure device (electrostatic charge image forming unit) 119Y that exposes the surface of the photoreceptor 111Y and to form an electrostatic charge image is disposed on the downstream side of the charging roll 118Y in the rotation direction of the photoreceptor 111Y.

Herein, a miniaturized LED array is used as the exposure device 119Y because of the space problem, but there is no limitation thereto, and the electrostatic charge image forming unit employing other laser beam or the like may be used. Herein, a wavelength of the power source is in a spectral sensitivity area of the photoreceptor. For example, when using the semiconductor laser, near infrared spectrum having an oscillation wavelength at approximately 780 nm is mainstream, but it is not limited to the wavelength, and a laser having an oscillation wavelength at approximately 600 nm, or a laser having an oscillation wavelength from 400 nm to 450 nm as a blue laser, may be used. In order to form a color image, a surface emitting laser light source which may output a multi beam is also effective.

Around the photoreceptor 111Y, a developing device (developing unit) 120Y including a developer holding member holding a yellow developer is disposed on the downstream side of to the exposure device 119Y in the rotation direction of the photoreceptor 111Y, the electrostatic charge image formed on the surface of the photoreceptor 111Y is developed by the yellow toner, and the toner image is formed on the surface of the photoreceptor 111Y.

The intermediate transfer belt 133 to which the toner image formed on the surface of the photoreceptor 111Y is primarily transferred is disposed below the photoreceptor 111Y so as to pass through the lower portion of five photoreceptors 111Y, 111M, 111C, 111K, and 111B. The intermediate transfer belt 133 is pressed against the surface of the photoreceptor 111Y by the primary transfer roll 117Y (primary transfer unit).

The intermediate transfer belt 133 is supported by three rolls of a driving roll 112, a support roll 113, and a bias roll 114, and is driven in an arrow B direction at a movement speed equivalent to the process speed of the photoreceptor 111Y. The driving roll 112 also functions as the intermediate transfer member charge erasing unit which erases charges accumulated in the intermediate transfer belt 133.

The yellow toner image is primarily transferred to the surface of the intermediate transfer belt 133, the magenta, cyan, black, and metallic toner images are then primarily transferred and stacked sequentially, and the charge erasing is performed by the driving roll 112.

A belt cleaner 116 which cleans an outer periphery surface of the intermediate transfer belt 133 is provided on the side opposite to the support roll 113 through the intermediate transfer belt 133, so as to be in press-contact with respect to the support roll 113. A voltage applying device 160 which is an arrangement unit which generates a difference in potential between the support roll 113 and the intermediate transfer belt 133 to generate an electric field between the intermediate transfer belt 133 and the support roll 113 is provided on the upstream side of the belt cleaner 116 of the intermediate transfer belt 133 in the rotation direction.

The intermediate transfer belt 133 preferably contains a polyimide resin or a polyamide-imide resin, in order to increase strength of the belt itself and satisfy longlife. Surface resistivity of the intermediate transfer belt 133 is preferably from 1×10⁹ Ω/□ to 1×10¹⁴ Ω/□. In order to control the surface resistivity, conductive filler is contained in the intermediate transfer belt 133, if necessary. As the conductive filler, metal or alloy such as carbon black, graphite, aluminum, or a copper alloy, metal oxide such as tin oxide, zinc oxide, potassium titanate, tin oxide-indium oxide or tin oxide-antimony oxide composite oxide, or a conductive polymer such as polyaniline are used alone or in combination of two or more kinds thereof. Among these, as the conductive filler, carbon black is preferable in a viewpoint of cost. A processing aid agent such as a dispersant or a lubricant may be added, if necessary.

Around the photoreceptor 111Y, a cleaning device 115Y for cleaning the toner remaining on the surface of the photoreceptor 111Y or retransferred toner is disposed on the downstream side of the primary transfer roll 117Y in the rotation direction (arrow A direction) of the photoreceptor 111Y. As the cleaning device 115Y, a cleaning blade type device is used as described above. The cleaning blade of the cleaning device 115Y is attached so as to be in press-contact to the surface of the photoreceptor 111Y in a counter direction.

A material of the cleaning blade is not particularly limited, and various elastic materials are used. Specific examples of the elastic member include a polyurethane elastic member, an elastic member such as silicone rubber or chloroprene rubber.

As the polyurethane elastic member, polyurethane synthesized by additional reaction of isocyanate with polyol, and various hydrogen-containing compounds, is generally used. This is manufactured by preparing an urethane prepolymer using polyether polyol such as polypropylene glycol and polytetramethylene glycol, or polyester polyol such as adipate polyol, polycaprolactam polyol, and polycarbonate polyol, as a polyol component, and using aromatic polyisocyanate such as tolylene diisocyanate, 4,4′-diphenylmethane diisocyanate, polymethylene polyphenyl polyisocyanate, and toluidine diisocyanate; or aliphatic polyisocyanate such as hexamethylene diisocyanate, isophorone diisocyanate, xylylene diisocyanate, dicyclohexylmethane diisocyanate, as an isocyanate component, adding a hardening agent to this, injecting this mixture to a die, performing crosslinking hardening, and aging at a room temperature (25° C.) As the hardening agent, divalent alcohol such as 1,4-butanediol and tri- or higher valent polyol such as trimethylol propane and pentaerythritol are generally used in combination.

When the rubber hardness (based on JIS K6253-3: 2012 durometer type A) of the cleaning blade is equal to or greater than 50°, the cleaning blade is hardly peeled off, and therefore passing of the toner hardly occurs. When the rubber hardness is equal to or smaller than 100°, the cleaning blade is not excessively hard, and accordingly the abrasion of the image holding member hardly proceeds, and the cleaning performance is hardly degraded.

If 300% modulus showing extension stress when elongation of the sample is 300% is equal to or greater than 80 kgf/cm², the blade edge is easily deformed and hardly torn, and accordingly, the cleaning blade has strong resistance against the cracks and abrasion, and the passing of toner hardly occurs. Meanwhile, when the 300% modulus is equal to or smaller than 550 kgf/cm², a following property due to the deformation of the cleaning blade with respect to the surface shape of the image holding member is hardly degraded, and accordingly, the cleaning defect due to the contact failure hardly occurs.

In addition, with the cleaning blade having impact resilience regulated by an impact resilience test method of JIS K-6255: 1996 (hereinafter, simply referred to as impact resilience) of 4% or more, the reciprocating operation of the toner scraping on the blade edge easily occurs, and the toner passing hardly occurs. In addition, in the cleaning blade having the impact resilience equal to or smaller than 85%, blade squeal or blade curling hardly occurs.

The indentation amount of the cleaning blade (deformation amount of the cleaning blade by being pressed against the surface of the image holding member) is not unconditionally determined, but is preferably approximately from 0.8 mm to 1.6 mm and more preferably approximately from 1.0 mm to 1.4 mm. A contact angle between the cleaning blade and the image holding member (angle formed by the tangent line of the surface of the image holding member and the cleaning blade) is not unconditionally determined, but is preferably approximately from 18° to 28°.

A secondary transfer roll (secondary transfer unit) 134 is in press-contact with the bias roll 114 supporting the intermediate transfer belt 133 through the intermediate transfer belt 133. The toner image which is primarily transferred to and stacked on the surface of the intermediate transfer belt 133 is electrostatically transferred to a surface of a recording sheet (recording medium) P fed from a paper cassette (not shown), in the press-contact portion of the bias roll 114 and the secondary transfer roll 134. In this case, since a metallic toner image is an image on the top (the uppermost layer) among the toner images transferred to and stacked on the intermediate transfer belt 133, the metallic toner image is an image on the bottom (lowermost layer) among the toner images transferred to the surface of the recording sheet P.

At the downstream side of the secondary transfer roll 134, fixing member (fixing unit) 135 for fixing the toner image multiply transferred to the recording sheet P to the surface of the recording sheet P by heat and pressure to obtain a permanent image is disposed.

As the fixing member 135, a fixing belt having a belt shape using a low surface energy material as typified by a fluororesin or a silicone resin on the surface, and a fixing roll having a cylindrical shape using a low surface energy material as typified by a fluororesin or a silicone resin on the surface are used, for example.

Next, the operations of the image forming units 150Y, 150M, 150C, 150K, and 150B that form the yellow, magenta, cyan, black, and metallic images will be described. Since the image forming units 150Y, 150M, 150C, 150K, and 1503 perform the same operation, the operation of the yellow image forming unit 150Y will be described as a representative.

In the yellow image forming unit 150Y, the photoreceptor 111Y rotates at a predetermined process speed in the arrow A direction. The surface of the photoreceptor 111Y is negatively charged to the predetermined potential by the charging roll 118Y. Then, the surface of the photoreceptor 111Y is exposed to the light by the exposure device 119Y, and an electrostatic charge image according to image information is formed. Next, the negatively charged toner is subjected to reversal development by the developing device 120Y, the electrostatic charge image formed on the surface of the photoreceptor 111Y is visualized on the surface of the photoreceptor 111Y, and the toner image is formed. After that, the toner image on the surface of the photoreceptor 111Y is primarily transferred to the surface of the intermediate transfer belt 133 by the primary transfer roll 117Y. After the primary transfer, the transfer residual components such as toner remaining on the surface of the photoreceptor 111Y is scraped and cleaned by the cleaning blade of the cleaning device 115Y, and the following image forming step is prepared.

The operations described above are performed by the image forming units 150Y, 150M, 150C, 150K, and 150B, and the toner images visualized on the surfaces of the photoreceptors 111Y, 111M, 111C, 111K, and 111B are sequentially subjected to multiple transfer to the surface of the intermediate transfer belt 133. In a color mode, the yellow, magenta, cyan, black, and metallic toner images are subjected to multiple transfer in this order, but also in a two-color mode or a three-color mode, the toner images with the necessary colors are transferred singly or subjected to multiple transfer in this order. The intermediate transfer belt 133 to which the toner images are transferred singly or subjected to multiple transfer, is subjected to charge erasing by the driving roll 112.

After that, the toner images which are transferred singly or subjected to multiple transfer to the surface of the intermediate transfer belt 133 are secondarily transferred to the surface of the recording sheet P which is fed from the paper cassette (not shown) by the secondary transfer roll 134, and then are fixed by heat and pressure applied by the fixing member 135. The toner remaining on the surface of the intermediate transfer belt 133 after the secondary transfer is subjected to a rising toner process with respect to the surface of the intermediate transfer belt 133 by the voltage applying device 160 which is the arrangement unit which generates an electric field between the intermediate transfer belt 133, and then is cleaned by the belt cleaner 116 configured with a cleaning blade for the intermediate transfer belt 133.

The yellow image forming unit 150Y is configured by integrating the developing device 120Y containing a developer holding member that holds the yellow electrostatic charge image developer, the photoreceptor 111Y, the charging roll 118Y, and the cleaning device 115Y, as a process cartridge detachable from an image forming apparatus. The image forming units 150B, 150K, 150C, and 150M are also configured as the process cartridges in the same manner as the image forming unit 150Y.

The toner cartridges 140Y, 140M, 140C, 140K, and 140B are cartridges that accommodate the toner with each color and are detachable from the image forming apparatus, and are connected to a developing device corresponding to each color through a toner supply tube (not shown). In addition, when the toner contained in each of the toner cartridges runs low, the toner cartridge is replaced.

In the exemplary embodiments, the charging rolls 118Y, 118M, 118C, 118K, and 118B as the charging devices are used, but there is no limitation thereto, and for example, a well-known charging member such as a contact-type charging member using a charging brush, a charging film, a charging rubber blade, or a charging tube, a non-contact-type roll charging member, a scorotron charger, or a corotron charger using corona discharge is also used.

In the exemplary embodiment, the primary transfer roll is used as the primary transfer unit and the secondary transfer roll is used as the secondary transfer unit, but there is no limitation thereto, and for example, a well-known transfer charging member such as a contact-type transfer charging member using a belt, a film, or a rubber blade, a scorotron charger, or a corotron charger using corona discharge may also be used.

In the image forming apparatus according to the exemplary embodiment, the arrangement unit which performs the rising toner process of the toner remaining on the surface of the intermediate transfer member after the transfer with respect to the surface of the intermediate transfer member is included, but an arrangement unit which performs a rising toner process of the toner remaining on the surface of the image holding member after the transfer with respect to the surface of the image holding member may be further included, or the arrangement units may not be included.

In the image forming apparatus according to the exemplary embodiment, the plural image forming units are configured as tandem types, but there is no limitation thereto, and the image forming unit that forms a toner image using the developer of the exemplary embodiment may only be provided.

Developer Cartridge/Process Cartridge/Toner Cartridge

A developer cartridge according to the exemplary embodiment will be described.

The developer cartridge according to the exemplary embodiment includes a container that accommodates the electrostatic charge image developer according to according to the exemplary embodiment, and is detachable from an image forming apparatus.

A process cartridge according to the exemplary embodiment will be described.

The process cartridge according to the exemplary embodiment is provided with a developing unit that accommodates the electrostatic charge image developer according to the exemplary embodiment and develops an electrostatic charge image formed on a surface of an image holding member with the electrostatic charge image developer to form a toner image, and is detachable from an image forming apparatus.

The process cartridge according to the exemplary embodiment is not limited to the above-described configuration, and may be configured to include a developing device, and if necessary, at least one selected from other units such as an image holding member, a charging unit, an electrostatic charge image forming unit, and a transfer unit.

Hereinafter, an example of the process cartridge according to the exemplary embodiment will be illustrated. However, the process cartridge is not limited thereto. Major parts shown in the drawing will be described, but descriptions of other parts will be omitted.

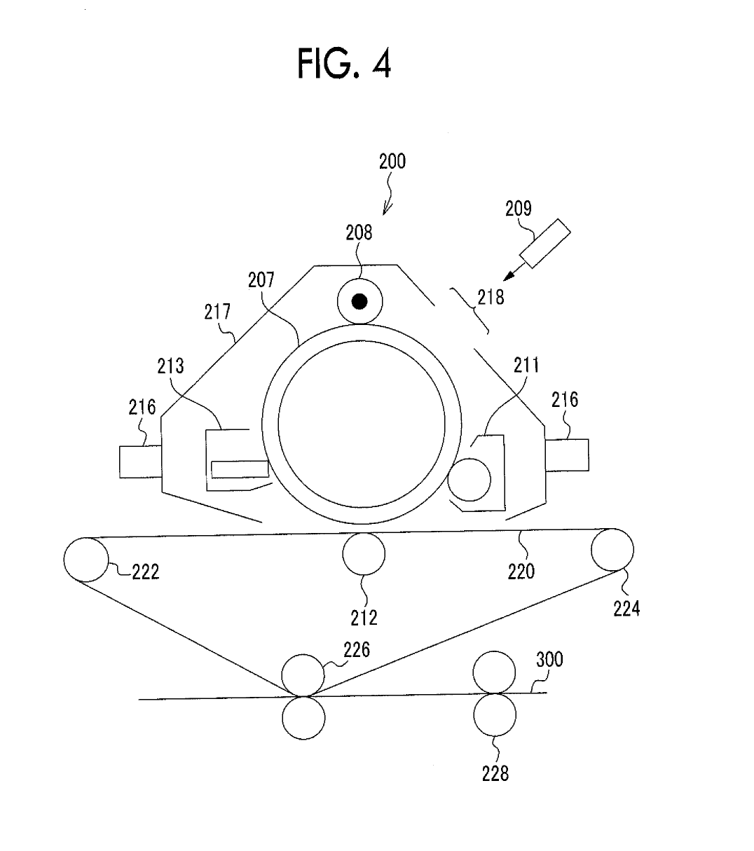

FIG. 4 is a schematic diagram showing a configuration of the process cartridge according to the exemplary embodiment.

A process cartridge 200 shown in FIG. 4 is formed as a cartridge having a configuration in which a photoreceptor 207 (an example of the image holding member), a charging roll 208 (an example of the charging unit), a developing device 211 (an example of the developing unit), and a photoreceptor cleaning device 213 (an example of the cleaning unit), which are provided around the photoreceptor 207, are integrally combined and held by the use of, for example, a housing 217 provided with a mounting rail 216 and an opening 218 for exposure.

In FIG. 4, the reference numeral 209 represents an exposure device (an example of the electrostatic charge image forming unit), the reference numeral 212 represents a primary transfer roll (an example of the primary transfer unit), the reference numeral 220 represents an intermediate transfer belt (an example of the intermediate transfer member), the reference numeral 222 represents a driving roll also functioning as an intermediate transfer belt charge erasing unit (an example of the intermediate transfer member charge erasing unit), the reference numeral 224 represents a support roll, the reference numeral 226 represents a secondary transfer roll (an example of the secondary transfer unit), the reference numeral 228 represents a fixing member (an example of the fixing unit), and the reference numeral 300 represents a recording sheet (an example of the recording medium).

Next, a toner cartridge according to the exemplary embodiment will be described.

The toner cartridge according to the exemplary embodiment accommodates the toner according to the exemplary embodiment and is detachable from an image forming apparatus. The toner cartridge accommodates a toner for replenishment to be supplied to the developing unit provided in the image forming apparatus.

### EXAMPLES

Hereinafter, the exemplary embodiment will be described in more detail using examples, but is not limited to the following examples. Unless specifically noted, “parts” and “%” are based on weight.

Preparation of Toner

Synthesis of Binder Resin
Dimethyl adipate: 74 parts
Dimethyl terephthalate: 192 parts
Bisphenol A ethylene oxide adduct: 216 parts
Ethylene glycol: 38 parts
Tetrabutoxytitanate (catalyst): 0.037 parts

The above components are added into a two-necked flask which is dried by heating, nitrogen gas is introduced in a container to maintain an inert atmosphere, and the components are heated while stirring, and then are subjected to co-condensation polymerization reaction for 7 hours at 160° C., and then a temperature thereof is increased to 220° C. while slowly reducing pressure thereof to 10 Torr and those are maintained for 4 hours. The pressure is temporarily returned to normal pressure, 9 parts of trimellitic anhydride is added, and the pressure thereof is slowly reduced again to 10 Torr and maintained for 1 hour at 220° C., to synthesize the binder resin.

The glass transition temperature (Tg) of the binder resin is obtained by measuring under the conditions of a temperature rising rate of 10° C./min from a room temperature (25° C.) to 150° C., using a differential scanning calorimeter (DSC-50 manufactured by Shimadzu Corporation), based on ASTMD 3418-8. The glass transition temperature is set to a temperature at intersection of extended lines of a base line and a rising line in an endothermic portion. The glass transition temperature of the binder resin is 63.5° C.

Preparation of Resin Particle Dispersion
Binder resin: 160 parts
Ethyl acetate: 233 parts
Sodium hydroxide aqueous solution (0.3 N): 0.1 parts

The above components are put in a 1000 ml separable flask, heated at 70° C., and stirred with THREE-ONE MOTER (manufactured by Shinto Scientific Co., Ltd.) to prepare a resin mixed. The resin mixed is further stirred at 90 rpm, 373 parts of the ion exchange water is slowly added therein to perform phase inversion emulsification, and the solvent thereof is removed to obtain resin particle dispersion (solid content concentration: 30%). A volume average particle diameter of the resin particles in the resin particle dispersion is 162 nm.

Preparation of Release Agent Dispersion
Carnauba wax (RC-160 manufactured by Toa Kasei Co., Ltd.): 50 parts
Anionic surfactant (NEOGEN RK manufactured by Dai-Ichi Kogyo Seiyaku Co., Ltd.): 1.0 part
Ion exchange water: 200 parts

The above components are mixed with each other and heated at 95° C., dispersed using a homogenizer (ULTRA-TURRAX T50 manufactured by IKA Ltd.), and then are subject to dispersion treatment with MANTON-GAULIN high pressure homogenizer (manufactured by Gaulin Co., Ltd.) for 360 minutes, and a release agent dispersion (solid content concentration: 20%) formed by dispersing the release agent particles having the volume average particle diameter of 0.23 μm is prepared.

Preparation of Brilliant Pigment Dispersion
Aluminum pigment (2173EA manufactured by SHOWA ALUMINUM POWDER K.K.): 100 parts
Anionic surfactant (NEOGEN R manufactured by Dai-Ichi Kogyo Seiyaku Co., Ltd.): 1.5 parts
Ion exchange water: 900 parts

After removing a solvent from the paste of the aluminum pigment, the above components are mixed, dissolved, and dispersed for approximately 1 hour using an emulsifying disperser CAVITRON (CR1010 manufactured by Pacific Machinery & Engineering Co., Ltd.), and a brilliant pigment dispersion in which the brilliant pigment particles (aluminum pigment) are dispersed (solid content concentration: 10%) is prepared.

Preparation of Toner Particles 1

Preparation of First Aggregated Particles (1)
Resin particle dispersion: 450 parts
Release agent dispersion: 50 parts
Nonionic surfactant (IGEPAL CA897): 1.4 parts

The above materials are put in a 2-liter cylindrical stainless container, dispersed and mixed for 10 minutes while applying a shear force at 4000 rpm using a homogenizer (ULTRA-TURRAX T50 manufactured by IKA Ltd.).

Then, 1.75 parts of 10% nitric acid aqueous solution of polyaluminum chloride is slowly added dropwise as an aggregating agent, the resultant material is dispersed and mixed for 15 minutes by setting a rotating speed of the homogenizer to 5000 rpm, and a dispersion is prepared.

After that, the dispersion is put in a reaction container including a stirring device using stirring blades of two paddles and a thermometer, heating is started with a mantle heater by setting a stirring rotation speed to 1550 rpm, and growth of aggregated particles is promoted at 54° C. At that time, pH of the dispersion is controlled to be in a range of 2.2 to 3.5 with 0.3 N nitric acid and 1 N sodium hydroxide aqueous solution. The dispersion is maintained in the pH range described above for about 1.0 hour and the first aggregated particles (1) are formed. A volume average particle diameter of the first aggregated particles (1) is shown in Table 1.

Addition of Brilliant Pigment and Preparation of Second Aggregated Particles (1)

Next, 365 parts of the brilliant pigment dispersion is added and the first aggregated particles (1) are attached to the surface of the brilliant pigment. The temperature is increased to 56° C., the aggregated particles are prepared while confirming a size and a form of the particle with an optical microscope and MULTISIZER II, and second aggregated particles (1) are formed.

Coalescence of Second Aggregated Particles (1)

Then, after increasing pH to 8.0, the temperature is increased to 67.5° C. After confirming that the second aggregated particles (1) are coalesced with the optical microscope, pH thereof is decreased to 6.0 while maintaining the temperature at 67.5° C., the heating is stopped after 1 hour, and cooling is performed at a temperature falling rate of 1.0° C./min. Then, after performing sieving with mesh of 40 μm and repeating water washing, the resultant material is dried with a vacuum drying machine to obtain toner particles 1.

Regarding the toner particles 1, the value of the A-B average distance obtained by the measurement method is shown in Table 1.

When the measurement by the method described above is performed regarding the toner particles 1, the percentage of the brilliant pigment particles having a volume average particle diameter of 10 μm, a ratio (C/D) of the toner particles of 0.06, and an angle between the long axis direction of the toner particles in cross section and the long axis direction of the brilliant pigment particles of −30° to +30° is 83%.

The ratio (C/D) of the brilliant pigment particles contained in the toner particles is 0.01 and a volume resistivity is 1×10⁻³ Ω·cm.

Preparation of Toner Particles 2

Preparation of Third Aggregated Particles (2)
Resin particle dispersion: 241.6 parts
Release agent dispersion: 25 parts
Brilliant pigment dispersion: 100 parts
Nonionic surfactant (IGEPAL CA897): 1.40 parts

The above materials are put in a 2-liter cylindrical stainless container, dispersed and mixed for 10 minutes while applying a shear force at 4000 rpm using a homogenizer (ULTRA-TURRAX T50 manufactured by IKA Ltd.).

Then, 1.75 parts of 10% nitric acid aqueous solution of polyaluminum chloride is slowly added dropwise as an aggregating agent, the resultant material is dispersed and mixed for 15 minutes by setting a rotating speed of the homogenizer to 5000 rpm, and a dispersion is prepared.

After that, the dispersion is put in a reaction container including a stirring device using stirring blades of two paddles and a thermometer, heating is started with a mantle heater by setting a stirring rotation speed to 810 rpm, and growth of aggregated particles is promoted at 54° C. At that time, pH of the dispersion is controlled to be in a range of 2.2 to 3.5 with 0.3 N nitric acid and 1 N sodium hydroxide aqueous solution. The dispersion is maintained in the pH range described above for about 1.5 hours and the third aggregated particles (2) having a volume average particle diameter of 5.1 μm are formed.

Addition of First Aggregated Particles (1) and Preparation of Fourth Aggregated Particles (2)

Next, 200 parts of the dispersion of the first aggregated particles (1) obtained in the preparation process of the toner particles 1 is added and the first aggregated particles (1) are attached to the surface of the third aggregated particles (2). The temperature thereof is increased to 56° C., the aggregated particles are prepared while confirming a size and a form of the particle with an optical microscope and MULTISIZER II, and fourth aggregated particles (2) are formed.

Coalescence of Fourth Aggregated Particles (2)

Then, after increasing pH to 8.0, the temperature is increased to 67.5° C. After confirming that the fourth aggregated particles (2) are coalesced with the optical microscope, pH thereof is decreased to 6.0 while maintaining the temperature at 67.5° C., the heating is stopped after 1 hour, and cooling is performed at a temperature falling rate of 1.0° C./min. Then, after performing sieving with mesh of 40 μm and repeating water washing, the resultant material is dried with a vacuum drying machine to obtain toner particles 2.

Regarding the toner particles 2, the value of the A-B average distance obtained by the measurement method is shown in Table 1.

When the measurement by the method described above is performed regarding the toner particles 2, the percentage of the brilliant pigment particles having a volume average particle diameter of 10.8 μm, a ratio (C/D) of the toner particles of 0.06, and an angle between the long axis direction of the toner particles in cross section and the long axis direction of the brilliant pigment particles of −30° to +30° is 85%.

Preparation of Toner Particles 3

Preparation of Fifth Resin Particles (3)

After increasing pH of the dispersion of the first aggregated particles (1) obtained in the preparation process of the toner particles 1 to 8.0, the temperature thereof is increased to 67.5° C. After confirming that the first aggregated particles (1) are coalesced with the optical microscope, pH thereof is decreased to 6.0 while maintaining the temperature at 67.5° C., the heating is stopped after 1 hour, and cooling is performed at a temperature falling rate of 1.0° C./min. Then, after performing sieving with mesh of 15 μm and repeating water washing, the resultant material is dried with a vacuum drying machine to obtain fifth resin particles (3). A volume average particle diameter of the fifth resin particles (3) is shown in Table 1.

Preparation of Sixth Toner Particles (3)

After increasing pH of the dispersion of the third aggregated particles (2) obtained in the preparation process of the toner particles 2 to 8.0, the temperature thereof is increased to 67.5° C. After confirming that the third aggregated particles (2) are coalesced with the optical microscope, pH thereof is decreased to 6.0 while maintaining the temperature at 67.5° C., the heating is stopped after 1 hour, and cooling is performed at a temperature falling rate of 1.0° C./min. Then, after performing sieving with mesh of 40 μm and repeating water washing, the resultant material is dried with a vacuum drying machine to obtain sixth toner particles (3).

Attachment of Fifth Resin Particles (3) and Sixth Toner Particles (3)

100 parts of the obtained fifth resin particles (3) and 200 parts of the sixth toner particles (3) are added into a sample mill (model name: SK-M 10 manufactured by Kyoritsu Riko K. K.) and stirred at a rotation rate of 13,000 rpm for 8 minutes, and accordingly, toner particles 3 are obtained.

Regarding the toner particles 3, the value of the A-B average distance obtained by the measurement method is shown in Table 1.

When the measurement by the method described above is performed regarding the toner particles 3, the percentage of the brilliant pigment particles having a volume average particle diameter of 8.5 μm, a ratio (C/D) of the toner particles of 0.12, and an angle between the long axis direction of the toner particles in cross section and the long axis direction of the brilliant pigment particles of −30° to +30° is 68%.

Preparation of Toner Particles 4

Preparation of First Aggregated Particles (4)
Resin particle dispersion: 450 parts
Release agent dispersion: 50 parts
Nonionic surfactant (IGEPAL CA897): 1.4 parts

The above materials are put in a 2-liter cylindrical stainless container, dispersed and mixed for 10 minutes while applying a shear force at 4000 rpm using a homogenizer (ULTRA-TURRAX T50 manufactured by IKA Ltd.).

Then, 1.75 parts of 10% nitric acid aqueous solution of polyaluminum chloride is slowly added dropwise as an aggregating agent, the resultant material is dispersed and mixed for 15 minutes by setting a rotating speed of the homogenizer to 5000 rpm, and a dispersion is prepared.

After that, the dispersion is put in a reaction container including a stirring device using stirring blades of two paddles and a thermometer, heating is started with a mantle heater by setting a stirring rotation speed to 1550 rpm, and growth of aggregated particles is promoted at 54° C. At that time, pH of the dispersion is controlled to be in a range of 2.2 to 3.5 with 0.3 N nitric acid and 1 N sodium hydroxide aqueous solution. The dispersion is maintained in the pH range described above for about 0.5 hours and the first aggregated particles (4) are formed. A volume average particle diameter of the first aggregated particles (4) is shown in Table 1.

Addition of Third Aggregated Particles (2) and Preparation of Fourth Aggregated Particles (4)

Next, 200 parts of the dispersion of the third aggregated particles (2) obtained in the preparation process of the toner particles 2 is added and the first aggregated particles (4) are attached to the surface of the third aggregated particles (2). The temperature thereof is increased to 56° C., the aggregated particles are prepared while confirming a size and a form of the particle with an optical microscope and MULTISIZER II, and fourth aggregated particles (4) are formed.

Coalescence of Fourth Aggregated Particles (4)

Then, after increasing pH to 8.0, the temperature is increased to 67.5° C. After confirming that the fourth aggregated particles (4) are coalesced with the optical microscope, pH thereof is decreased to 6.0 while maintaining the temperature at 67.5° C., the heating is stopped after 1 hour, and cooling is performed at a temperature falling rate of 1.0° C./min. Then, after performing sieving with mesh of 40 μm and repeating water washing, the resultant material is dried with a vacuum drying machine to obtain toner particles 4.

Regarding the toner particles 4, the value of the A-B average distance obtained by the measurement method is shown in Table 1.

When the measurement by the method described above is performed regarding the toner particles 4, the percentage of the brilliant pigment particles having a volume average particle diameter of 8.2 μm, a ratio (C/D) of the toner particles of 0.07, and an angle between the long axis direction of the toner particles in cross section and the long axis direction of the brilliant pigment particles of −30° to +30° is 79%.

Preparation of Toner Particles 11
Resin particle dispersion: 241.6 parts
Release agent dispersion: 25 parts
Brilliant pigment dispersion: 100 parts
Nonionic surfactant (IGEPAL CA897): 1.40 parts

The above materials are put in a 2-liter cylindrical stainless container, dispersed and mixed for 10 minutes while applying a shear force at 4000 rpm using a homogenizer (ULTRA-TURRAX T50 manufactured by IKA Ltd.).

Then, 1.75 parts of 10% nitric acid aqueous solution of polyaluminum chloride is slowly added dropwise as an aggregating agent, the resultant material is dispersed and mixed for 15 minutes by setting a rotating speed of the homogenizer to 5000 rpm, and a dispersion is prepared.

After that, the dispersion is put in a reaction container including a stirring device using stirring blades of two paddles and a thermometer, heating is started with a mantle heater by setting a stirring rotation speed to 810 rpm, and growth of aggregated particles is promoted at 54° C. At that time, pH of the dispersion is controlled to be in a range of 2.2 to 3.5 with 0.3 N nitric acid and 1 N sodium hydroxide aqueous solution. The dispersion is maintained in the pH range described above for about 2 hours and the aggregated particles (11) having a volume average particle diameter of 10.4 μm are formed.

Then, after increasing pH to 8.0, the temperature is increased to 67.5° C. After confirming that the aggregated particles (11) are coalesced with the optical microscope, pH thereof is decreased to 6.0 while maintaining the temperature at 67.5° C., the heating is stopped after 1 hour, and cooling is performed at a temperature falling rate of 1.0° C./min. Then, after performing sieving with mesh of 40 μm and repeating water washing, the resultant material is dried with a vacuum drying machine to obtain toner particles 11.

Regarding the toner particles 11, the value of the A-B average distance obtained by the measurement method is shown in Table 1.

When the measurement by the method described above is performed regarding the toner particles 11, the percentage of the brilliant pigment particles having a volume average particle diameter of 11.1 μm, a ratio (C/D) of the toner particles of 0.074, and an angle between the long axis direction of the toner particles in cross section and the long axis direction of the brilliant pigment particles of −30° to +30° is 94%.

Preparation of Toner Particles 12

Preparation of First Aggregated Particles (12)
Resin particle dispersion: 450 parts
Release agent dispersion: 50 parts
Nonionic surfactant (IGEPAL CA897): 1.4 parts

The above materials are put in a 2-liter cylindrical stainless container, dispersed and mixed for 10 minutes while applying a shear force at 4000 rpm using a homogenizer (ULTRA-TURRAX 150 manufactured by IKA Ltd.).

Then, 1.75 parts of 10% nitric acid aqueous solution of polyaluminum chloride is slowly added dropwise as an aggregating agent, the resultant material is dispersed and mixed for 15 minutes by setting a rotating speed of the homogenizer to 5000 rpm, and a dispersion is prepared.

After that, the dispersion is put in a reaction container including a stirring device using stirring blades of two paddles and a thermometer, heating is started with a mantle heater by setting a stirring rotation speed to 1550 rpm, and growth of aggregated particles is promoted at 54° C. At that time, pH of the dispersion is controlled to be in a range of 2.2 to 3.5 with 0.3 N nitric acid and 1 N sodium hydroxide aqueous solution. The dispersion is maintained in the pH range described above for about 3.0 hours and the first aggregated particles (12) are formed. A volume average particle diameter of the first aggregated particles (12) is shown in Table 1.

Addition of Third Aggregated Particles (2) and Preparation of Fourth Aggregated Particles (12)

Next, 200 parts of the dispersion of the third aggregated particles (2) obtained in the preparation process of the toner particles 2 is added and the first aggregated particles (12) are attached to the surface of the third aggregated particles (2). The temperature thereof is increased to 56° C., the aggregated particles are prepared while confirming a size and a form of the particle with an optical microscope and MULTISIZER II, and fourth aggregated particles (12) are formed.

Coalescence of Fourth Aggregated Particles (12)

Then, after increasing pH to 8.0, the temperature is increased to 67.5° C. After confirming that the fourth aggregated particles (12) are coalesced with the optical microscope, pH thereof is decreased to 6.0 while maintaining the temperature at 67.5° C., the heating is stopped after 1 hour, and cooling is performed at a temperature falling rate of 1.0° C./min. Then, after performing sieving with mesh of 40 μm and repeating water washing, the resultant material is dried with a vacuum drying machine to obtain toner particles 12.

Regarding the toner particles 12, the value of the A-B average distance obtained by the measurement method is shown in Table 1.

When the measurement by the method described above is performed regarding the toner particles 12, the percentage of the brilliant pigment particles having a volume average particle diameter of 12.4 μm, a ratio (C/D) of the toner particles of 0.08, and an angle between the long axis direction of the toner particles in cross section and the long axis direction of the brilliant pigment particles of −30° to +30° is 73%.

Preparation of Toner

1.5 parts of a hydrophobic silica (RY50 manufactured by Nippon Aerosil Co., Ltd.) and 1.0 part of hydrophobic titanium oxide (T805 manufactured by Nippon Aerosil Co., Ltd.) are mixed with 100 parts of the toner particle for 30 seconds at 10,000 rpm by using a sample mill. Next, the resultant material is sieved with a vibration sieving machine having mesh of 45 μm, and toner is obtained.

Preparation of Carrier
Ferrite particles (volume average particle diameter: 35 μm): 100 parts
Toluene: 14 parts
Perfluoroacrylate copolymer (critical surface tension: 24 dyn/cm): 1.6 parts
Carbon black (product name: VXC-72 manufactured by Cabot Corporation, volume resistivity: 100 Ωm or lower): 0.12 parts
Crosslinked melamine resin particles (average particle diameter: 0.3 μm, toluene-insoluble): 0.3 parts

First, carbon black is diluted with toluene and added to the perfluoroacrylate copolymer and dispersed with a sand mill. Then, each component other than the ferrite particles is dispersed therein with a stirrer for 10 minutes, and a coating layer forming solution is blended. Then, after putting the coating layer forming solution and the ferrite particles in a vacuum deaeration type kneader and stirring for 30 minutes at a temperature of 60° C., the pressure of the resultant material is reduced and toluene is distilled to form a resin coating layer and obtain a carrier.

Preparation of Developer

36 parts of the toner and 414 parts of the carrier are put in 2 liter V-blender, stirred for 20 minutes, and then sieved with mesh of 212 μm to prepare a developer.

Evaluation Test

A solid image is formed with the following method.

A developing device of an image forming apparatus of intermediate transfer system including an intermediate transfer member erasing unit (DOCUCENTRE-III C7600 manufactured by Fuji Xerox Co., Ltd.) is filled with a sample developer, and a 10 cm×10 cm solid image having a toner applied amount of 4.5 g/cm² is formed on a recording sheet (OK TOPCOAT+, manufactured by Oji Paper Co., Ltd.) at a fixing temperature of 190° C. and fixing pressure of 4.0 kg/cm².

Measurement of Ratio (X/Y)

An image portion of the formed solid image is irradiated with the incident light at an angle of incidence of −45° with respect to the solid image, and a reflectance X at a light receiving angle of +30° and a reflectance Yat a light receiving angle of −30° are measured by using, as a goniophotometer, a spectrophotometric type variable angle color difference meter GC5000L manufactured by Nippon Denshoku Industries Co., Ltd. Each of the reflectance X and the reflectance Y is measured regarding the light having a wavelength of 400 nm to 700 nm at intervals of 20 nm, and defined as an average value of the reflectances at respective wavelengths. The ratio (X/Y) is calculated from these measurement results. Results thereof are shown in Table 1.

Evaluation of Image Defect Caused by Scattering of Toner

For the obtained solid image, the scattering of the toner (scattering of toner from the image portion to the non-image portion) of the boundary portion of the image (boundary portion between the image portion and the non-image portion at the upstream side and the downstream side in the travelling direction) is visually observed. Evaluation criteria are as follows and the results are shown in Table 1.

G1: No scattering is observed at the upstream side and the downstream side.

G2: Scattering is slightly observed at the upstream side but no scattering is observed at the downstream side.

G3: scattering is observed at the upstream side and the downstream side but it is in an acceptable range.

G4: Scattering observed is beyond the acceptable range.

TABLE 1

| | | | First aggregated | | | | |
|---|---|---|---|---|---|---|---|
| | | | particles or fifth | | | | |
| | | | resin particles | | | | |
| | | | | Volume average | A-B average | evaluation | |
| | Toner | | | particle diameter | distance | Ratio | Image |
| | particles | Method | Type | (μm) | (μm) | (X/Y) | defect |
| Ex. 1 | 1 | (1) | (1) | 1.8 | 1.8 | 70 | G1 |
| Ex. 2 | 2 | (2) | (1) | 1.8 | 2.1 | 60 | G1 |
| Ex. 3 | 3 | (3) | (3) | 2.1 | 1.4 | 48 | G3 |
| Ex. 4 | 4 | (2) | (4) | 1.1 | 1.7 | 78 | G2 |
| Com. Ex. 1 | 11 | — | — | — | 0.7 | 83 | G4 |
| Com. Ex. 2 | 12 | (2) | (12) | 3.7 | 4.8 | 1.3 | G1 |

In Table 1, the numbers in the column “method” indicates the numbers of the preparation methods of the toner particles and “-” indicates the preparation method of the toner particles in the related art.

From the results, it is found that the image defect caused by the scattering of the toner is prevented in Examples, compared to Comparative Example 1.

From the above results, it is found that the image having a high brilliant property is obtained with the high value of the ratio (X/Y) in Examples, compared to Comparative Example 2.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
flake shape toner particles containing a binder resin and a flake shape brilliant pigment,
and the toner particles satisfying the following expression:
1≦L≦3
wherein L represents an average distance (μm) between a tangent line A of the toner particle that is orthogonal to a long axis direction of the toner particle and a tangent line B of the brilliant pigment that is parallel to the tangent line A and closest to the tangent line A.

2. The electrostatic charge image developing toner according to claim 1,
wherein the brilliant pigment is a metallic pigment.

3. The electrostatic charge image developing toner according to claim 1,
wherein the brilliant pigment is an aluminum pigment.

4. The electrostatic charge image developing toner according to claim 1,
wherein the value of L is from 1.3 to 2.7.

5. The electrostatic charge image developing toner according to claim 1,
wherein the toner particles satisfy the following expression:
0.005≦C/D≦0.700
wherein D represents an average diameter (μm) of equivalent circle diameters of maximum proj ection areas of the toner particles and C represents an average length (μm) of maximum lengths of thicknesses orthogonal to the maximum projection areas of the toner particles.

6. The electrostatic charge image developing toner according to claim 1,
wherein the electrostatic charge image developing toner satisfies the following expression:
20≦X/Y≦90
wherein X represents a reflectance at a light receiving angle of +30° measured with a solid image that is irradiated with incident light at an angle of incidence of −45° by a goniophotometer, and Y represents a reflectance at a light receiving angle of −30° measured with the image that is irradiated with incident light at an angle of incidence of −45° by a goniophotometer.

7. The electrostatic charge image developing toner according to claim 1,
wherein a volume average particle diameter of the toner particles is from 8 μm to 20 μm.

8. An electrostatic charge image developer comprising the electrostatic charge image developing toner according to claim 1, and a carrier.

9. A developer cartridge comprising:
a container that accommodates the electrostatic charge image developer according to claim 8,
and the cartridge being detachable from an image forming apparatus.

10. A process cartridge comprising:
a developing unit that accommodates the electrostatic charge image developer according to claim 8 and develops an electrostatic charge image formed on a surface of an image holding member as a toner image with the electrostatic charge image developer,
wherein the process cartridge is detachable from an image forming apparatus.

11. An image forming apparatus comprising:
an image holding member;
a charging unit that charges a surface of the image holding member;
an electrostatic charge image forming unit that forms an electrostatic charge image on a charged surface of the image holding member;
a developing unit that accommodates the electrostatic charge image developer according to claim 8 and develops the electrostatic charge image formed on the surface of the image holding member as a toner image with the electrostatic charge image developer;
a transfer unit that transfers the toner image formed on the surface of the image holding member onto a surface of a recording medium; and
a fixing unit that fixes the toner image transferred onto the surface of the recording medium.
